(19) United States
(12) Patent Application Publication
(10) Pub. No.: US 2012/0183838 A1
(43) Pub. Date: Jul. 19, 2012

(54) BATTERY PACK AND BATTERY PACK MODULE

(75) Inventors: Jinhong An, Yongin-si (KR); Jeongdeok Byun, Yongin-si (KR)

(73) Assignee: Samsung SDI Co., Ltd., Yongin-si (KR)

(21) Appl. No.: 13/096,956

(22) Filed: Apr. 28, 2011

(30) Foreign Application Priority Data
Jan. 13, 2011 (KR) 10-2011-003604

(51) Int. Cl. H01M 2/20; H01M 2/10

(52) U.S. Cl. 429/158

(57) ABSTRACT

A battery pack and a battery pack module are disclosed. In one embodiment, the battery pack includes i) a plurality of battery cells each including a first conductive terminal and a second conductive terminal, wherein the battery cells are electrically connected in parallel to each other, ii) a plurality of first conductive tabs respectively connected to the first conductive terminals and extending in a first direction and iii) a plurality of second conductive tabs respectively connected to the second conductive terminals and extending in a second direction substantially opposite to the first direction, wherein the first conductive tabs face and correspond to the second conductive tabs, respectively. In one embodiment, a selected one of the first conductive tabs has a thickness different from that of the corresponding second conductive tab.

### CROSS-REFERENCE TO RELATED APPLICATION

This application claims priority to and the benefit of Korean Patent Application No. 10-2011-0003604, filed on Jan. 13, 2011, the entire content of which is incorporated herein by reference.

### BACKGROUND

1. Field

The described technology generally relates to a battery pack and a battery pack module.

2. Description of the Related Technology

Battery packs are widely used in portable electronic devices, such as notebook computers, personal digital assistants (PDAs), and camcorders. A typical battery pack includes multiple battery cells, since an individual battery cell has a limited power capacity. When a larger capacity than a portable electronic device requires, say, for an electric vehicle or an uninterruptible power system (UPS), a plurality of battery packs are electrically connected and are often stacked together and connected using bus bars in a battery pack module.

### SUMMARY

One inventive aspect is a battery pack and a battery pack module, which can reduce the manufacturing cost and yield by varying the thickness of an electrode tab or a bus bar.

Another aspect is a battery pack, including a plurality of battery cells each including a first conductive terminal and a second conductive terminal and arranged from a first direction to a second direction opposite to the first direction to be connected in a parallel to each other, first conductive tabs electrically connecting the first conductive terminals of the plurality of battery cells and drawn out in the first direction, and second conductive tabs electrically connecting the second conductive terminals of the plurality of battery cells and drawn out in the second direction, wherein the first conductive tab and the second conductive tab have different thickness at one end of at least one of the first and second directions in which the first conductive tabs and the second conductive tabs are drawn out, respectively.

The first conductive tabs and the second conductive tabs may have stepped cross sections of their top or bottom surfaces. In addition, the first conductive tabs and the second conductive tabs may have oblique cross sections of their top or bottom surfaces. Here, the first conductive tabs and the second conductive tabs may be formed on the top surface and the bottom surface of the plurality of battery cells, respectively. In addition, the first conductive tabs and the second conductive tabs may be formed to be spaced apart from each other on the top or bottom surfaces of the plurality of battery cells. Here, a sum of thicknesses of the first conductive tab and the second conductive tab formed in each of the plurality of battery cells may be constant. Additionally, the first conductive tab and the second conductive tab may be made of any one of nickel (Ni), copper (Cu), aluminum (Al) and equivalents thereof, or combinations of these materials.

The battery pack may further include a first conductive external terminal electrically connected to the first direction of the first conductive tab and electrically connected to the outside, and a second conductive external terminal electrically connected to the second direction of the second conductive tab and electrically connected to the outside. Here, the first conductive tab and the first conductive external terminal may be electrically connected by a first conductive wire, and the second conductive tab and the second conductive external terminal may be electrically connected by a second conductive wire. In addition, the battery pack may further include a battery case accommodating the plurality of battery cells therein and fixing the first conductive external terminal and the second conductive external terminal. The battery cells may be cylindrical rechargeable batteries.

Another aspect is a battery pack module, including a plurality of battery packs each including a first conductive terminal and a second conductive terminal and arranged from a first direction to a second direction opposite to the first direction to be connected in parallel to each other, first conductive bus bars electrically connecting the first conductive terminals of the plurality of battery packs and drawn out in the first direction, and second conductive bus bars electrically connecting the second conductive terminals of the plurality of battery packs and drawn out in the second direction, wherein the first conductive bus bar and the second conductive bus bar may have different thickness at one end of at least one of the first and second directions in which the first conductive bus bars and the second conductive bus bars are drawn out, respectively.

The first conductive bus bars and the second conductive bus bars may have stepped cross sections of their top or bottom surfaces. In addition, the first conductive bus bars and the second conductive bus bars may have oblique cross sections of their top or bottom surfaces. Here, a sum of thicknesses of the first conductive bus bar and the second conductive bus bar formed in each of the plurality of battery packs may be constant. In addition, the battery pack may include a plurality of battery cells each including a first conductive terminal and a second conductive terminal and electrically connected in parallel to each other, and a battery case accommodating the plurality of battery cells therein and fixing the first conductive external terminal and the second conductive external terminal. The plurality of battery cells may be arranged from a third direction to a fourth direction opposite to the third direction and may include first conductive tabs electrically connecting the first conductive terminals of the plurality of battery cells and drawn out in the third direction, and second conductive tabs electrically connecting the second conductive terminals of the plurality of battery cells and drawn out in the fourth direction, and the first conductive tabs and the second conductive tabs may be formed to be gradually thicker in the third or fourth direction in which they are drawn out.

Another aspect is a battery pack comprising: a plurality of battery cells each including a first conductive terminal and a second conductive terminal, wherein the battery cells are electrically connected in parallel to each other; a plurality of first conductive tabs respectively connected to the first conductive terminals and extending in a first direction; and a plurality of second conductive tabs respectively connected to the second conductive terminals and extending in a second direction substantially opposite to the first direction, wherein the first conductive tabs face and correspond to the second conductive tabs, respectively, wherein a selected one of the first conductive tabs has a thickness different from that of the corresponding second conductive tab.

In the above battery pack, each of the first conductive tabs has first top and first bottom surfaces, wherein the first bottom surfaces contact the first conductive terminals, respectively, wherein each of the second conductive tabs has second top and second bottom surfaces, and wherein the second top surfaces contact the second conductive terminals, respectively. In the above battery pack, the first conductive tabs have stepped cross sections along the first top surfaces, and wherein the second conductive tabs have stepped cross sections along the second bottom surfaces.

In the above battery pack, the first conductive tabs have oblique cross sections along the first top surfaces and wherein the second conductive tabs have oblique cross sections along the second bottom surfaces. In the above battery pack, the thicknesses of the first conductive tabs gradually decrease in the first direction, and wherein the thicknesses of the second conductive tabs gradually decrease in the second direction.

In the above battery pack, the sum of thicknesses of a selected first conductive tab and the corresponding second conductive tab is substantially constant. In the above battery pack, each of the first conductive tabs and each of the second conductive tabs are formed of at least one of the following: nickel (Ni), copper (Cu) and aluminum (Al). The above battery pack further comprises: a first conductive external terminal electrically connected to the first conductive tabs; and a second conductive external terminal electrically connected to the second conductive tabs.

In the above battery pack, the first conductive tabs and the first conductive external terminals are electrically connected to each other via a first conductive wire, and wherein the second conductive tabs and the second conductive external terminals are electrically connected to each other via a second conductive wire. The above battery pack further comprises a battery case accommodating the battery cells therein, wherein the first and second conductive external terminals are attached to the battery case. In the above battery pack, the battery cells are cylindrical rechargeable batteries. In the above battery pack, the first and second conductive terminals are formed on the opposite sides of the battery cells.

Another aspect is a battery pack module comprising: a plurality of battery packs each including a first conductive external terminal and a second conductive external terminal, wherein the battery packs are electrically connected in parallel to each other; a plurality of first conductive bus bars respectively connected to the first conductive external terminals and extending in a first direction; and a plurality of second conductive bus bars respectively connected to the second conductive external terminals and extending in a second direction substantially opposite to the first direction, wherein the first conductive bus bars face and correspond to the second conductive bus bars, respectively, and wherein the first conductive bus bars are arranged substantially parallel with the second conductive bus bars, wherein a selected one of the first conductive bus bars has a thickness different from that of the corresponding second conductive bus bar.

In the above battery pack module, each of the first conductive bus bars has first top and first bottom surfaces, wherein the first bottom surfaces contact the first conductive external terminals, respectively, wherein each of the second conductive bus bars has second top and second bottom surfaces, and wherein the second bottom surfaces contact the second conductive terminals, respectively. In the above battery pack module, the first conductive bus bars have stepped cross sections along the first top surfaces, and wherein the second conductive bus bars have stepped cross sections along the second top surfaces.

In the above battery pack module, the first conductive bus bars have oblique cross sections along the first top surfaces and wherein the second conductive bus bars have oblique cross sections along the second top surfaces. In the above battery pack module, the thicknesses of the first conductive bus bars gradually decrease in the first direction, and wherein the thicknesses of the second conductive bus bars gradually decrease in the second direction. In the above battery pack module, the first and second conductive external terminals are formed on the same side of the battery cells.

Another aspect is a battery pack comprising: a plurality of battery cells each including a first conductive terminal and a second conductive terminal, wherein the battery cells are electrically connected in parallel to each other; a plurality of first conductive tabs respectively connected to the first conductive terminals and extending in a first direction; and a plurality of second conductive tabs respectively connected to the second conductive terminals and extending in a second direction substantially opposite to the first direction, wherein the first conductive tabs face and correspond to the second conductive tabs, respectively, wherein the thicknesses of the first conductive tabs gradually decrease in the first direction, and wherein the thicknesses of the second conductive tabs gradually decrease in the second direction.

In the above battery pack, the sum of thicknesses of a selected first conductive tab and the corresponding second conductive tab is substantially constant.

### BRIEF DESCRIPTION OF THE DRAWINGS

FIG. 1 is a perspective view illustrating an assembled state of a battery cell and an electrode tab of a battery pack according to an embodiment.

FIG. 2 is a plan view of a battery pack according to an embodiment.

FIG. 3 is a plan view of a battery pack according to another embodiment.

FIG. 4 is a perspective of a battery pack module according to still another embodiment.

FIG. 5 is a perspective of a battery pack module according to still another embodiment.

### DETAILED DESCRIPTION

A typical battery pack is configured such that positive electrodes and negative electrodes are all drawn out from a plurality of battery cells of one side to then be electrically connected to an external device when the battery cells electrically connected in parallel to each other are housed therein. Likewise, the corresponding battery pack module has a similar configuration where positive electrodes and negative electrodes are all drawn out from a plurality of battery packs of one side to then be electrically connected to an external device when the battery packs electrically connected in parallel to each other are included therein.

In the above battery pack or battery pack module, however, when it is connected to an external device for charging and discharging, the charging and discharging more quickly occur in the battery cells or battery packs located in the side where positive and negative electrodes are all drawn out than in the battery cells or battery packs of the opposite side. Thus, a large amount of heat is generated from the battery cells or battery packs in that location, compared to the battery cells or battery packs located in the opposite side. As the charging and discharging are repeatedly performed, deterioration may become severe particularly in the area where a large amount of heat is generated. Accordingly, overall the life spans of the battery cells and the battery packs are reduced.

Embodiments will be described with reference to the accompanying drawings, wherein like reference numerals refer to the like elements throughout.

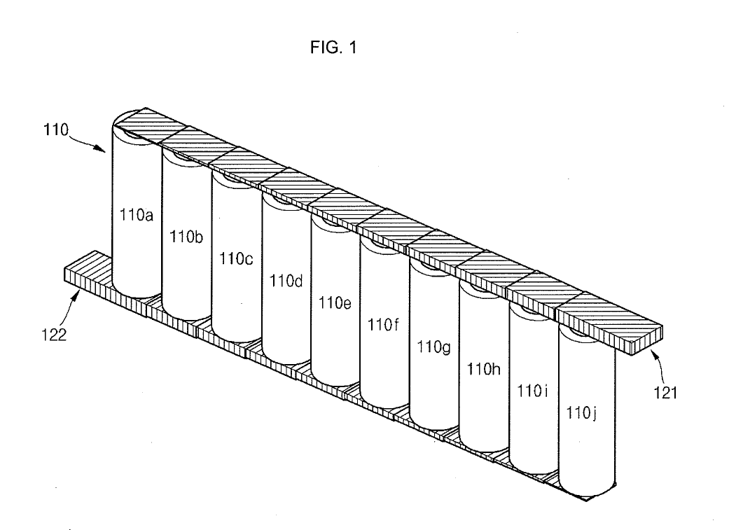

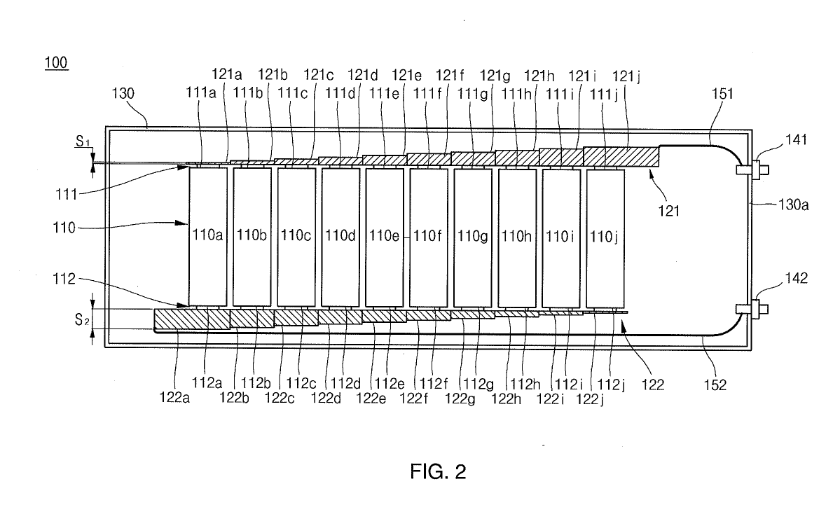

FIG. 1 is a perspective view illustrating an assembled state of a battery cell and an electrode tab of a battery pack according to an embodiment., and FIG. 2 is a plan view of a battery pack according to an embodiment.

Referring to FIGS. 1 and 2, the battery pack 100 includes a plurality of battery cells 110, a first conductive tab 121, a second conductive tab 122, a battery case 130, a first conductive external terminal 141, second conductive external terminal 142, a first conductive wire 151 and a second conductive wire 152.

Each of the battery cells 110 includes a first conductive terminal 111 and a second conductive terminal 112, and the battery cells 110 may be arranged from a first direction to a second direction substantially opposite to the first direction to then be connected in parallel to each other. The battery cells 110 may be cylindrical batteries. In addition, the battery cells 110 may be secondary batteries capable of charging and discharging, In particular, the battery cells 110 may be cylindrical lithium secondary batteries having a high operating voltage of about 3.6 V or higher and a high energy density per weight. Although FIGS. 1 and 2 illustrate 10 battery cells 110, but the number of the battery cells 110 is not limited thereto. The plurality of battery cells 110 may be defined as first to 10th battery cells 110a, 110b, 110c, 110d, 110e, 110f, 110g, 110h, 110i, and 110j. The plurality of battery cells 110 may be arranged in substantially parallel from the first direction to the second direction.

The first conductive terminals 111 may be formed at upper portions of the battery cells 110. In addition, the first conductive terminals 111 may be electrically connected to a positive electrode of an electrode assembly (not shown) to have positive polarity.

The second conductive terminals 112 may be formed at lower portions of the battery cells 110. In addition, the second conductive terminals 112 may be electrically connected to a negative electrode of an electrode assembly (not shown) to have negative polarity.

The first conductive tab 121 is formed to electrically connect the first to 10th first conductive terminals 111a, 111b, 111c, 111d, 111e, 111f, 111g, 111h, 111i and 111j (111a-111j) of the first to 10^{th} battery cells 110a, 110b, 110c, 110d, 110e, 110f, 110g, 110h, 110i and 110j (110a-110j) to then be drawn out (or extend) in a first direction. That is to say, the first conductive tab 121 may be formed at upper portions of the first conductive terminals 111a-111j. Here, the first conductive tab 121 may be made of any one of nickel (Ni), copper (Cu), aluminum (Al) and equivalents thereof, or combinations of these materials. However, the material of the first conductive tab 121 is not limited to those listed herein. In addition, the first conductive tab 121 may be formed to have a stepped cross section of top surface substantially gradually increasing in the first direction in which it is drawn out. That is to say, the first conductive tab 121 may be formed to be substantially gradually thicker from the second direction to first direction, the second direction opposite to the first direction. Although FIGS. 1 and 2 illustrate the first conductive tab 121 including a plurality of tabs connected on the first conductive terminals 111a-111j, this structure is not considered limiting. However, plate-shaped conductive tabs connecting the first conductive terminals 111a-111j to each other may be stacked and formed stepwise.

The second conductive tab 122 is formed to electrically connect the first to 10th second conductive terminals 112a, 112b, 112c, 112d, 112e, 112f, 112g, 112h, 112i and 112j (112a-112j) of the first to 10^{th} battery cells 110a-110j to then be drawn out (or extend) in a second direction. That is to say, the second conductive tab 121 may be formed at lower portions of the second conductive terminals 112a-112j. Here, the second conductive tab 122 may be made of any one of nickel (Ni), copper (Cu), aluminum (Al) and equivalents thereof, or combinations of these materials. However, the material of the second conductive tab 122 is not limited to those listed herein. In addition, the second conductive tab 122 may be formed to have a stepped cross section of bottom surface gradually increasing in the second direction in which it is drawn out. That is to say, the second conductive tab 122 may be formed to be substantially gradually thicker from the first direction to second direction, the first direction opposite to the second direction. Although FIGS. 1 and 2 illustrate the second conductive tab 122 including a plurality of tabs connected on the second conductive terminals 112a-112j, this structure is not considered limiting. However, plate-shaped conductive tabs connecting the second conductive terminals 112a-112j to each other may be stacked and formed stepwise.

Thicknesses of the aforementioned first and second conductive tabs 121 and 122 at an end of at least one of the first or second directions, in which the first and second conductive tabs 121 and 122 are drawn out may be different from each other.

The first conductive tab 121 and the second conductive tab 122 may be formed to be spaced apart from each other at top and bottom surfaces of the plurality of battery cells 110a-110j, respectively. In addition, the sum of thicknesses of the first conductive tab 121 and the second conductive tab 122 formed in each of the battery cells 110a-110j may be constant. That is to say, in one embodiment, as expressed in Equation (1), the sum S of the thickness S1 of the first conductive tab 121 and thickness S2 of the second conductive tab 122 is always constant:

S=S1+S2 (1)

The battery case 130 may be shaped of a box having an internal space. The battery case 130 may be formed to house the battery cells 110, the first conductive tab 121 and the second conductive tab 122 in the internal space. In addition, the battery case 130 may be formed to fix a first conductive external terminal 141 and a second conductive external terminal 142, which will later be described. Also, the battery case 130 may be made of an insulating resin. Further, the battery case 130 may protect the battery cells 110 housed therein from external surroundings, such as external impacts or dust.

The first conductive external terminal 141 may be formed on one side surface 130a of the battery case 130 close to the battery cell 110j among the plurality of battery cells 110, which is positioned close to the side from which the first conductive tab 121 is drawn out. In addition, the first conductive external terminal 141 may be electrically connected to the first conductive tab 121. Further, the first conductive external terminal 141 may be exposed out of the battery case 130 to be electrically connected to another battery pack or electronic device.

The second conductive external terminal 142 may be formed on the one side surface 130a of the battery case 130, on which the first conductive external terminal 141 is formed. In addition, the second conductive external terminal 142 may be electrically connected to the side from which the second conductive tab 122 is drawn out. Further, the second conductive external terminal 142 may be exposed outside the battery case 130 to be electrically connected to another battery pack or electronic device.

Since the first conductive external terminal 141 and the second conductive external terminal 142 are formed on the one side surface 130a of the battery case 130, a battery pack module having a battery pack stack structure may be formed, in which the plurality of battery packs 100 are stacked one on the other.

The first conductive wire 151 may be formed to electrically connect the side from which the first conductive tab 121 is drawn out to the first conductive external terminal 141. In addition, the first conductive wire 151 is formed on the one side surface 130a of the battery case 130, which is positioned close to the side from which the first conductive tab 121 is drawn out, and is relatively short. In addition, the first conductive wire 151 is formed of a wire made of any one metal of nickel (Ni), copper (Cu), aluminum (Al) and equivalents thereof, or combinations of these materials and coated with an insulating resin. However, the material of the first conductive wire 151 is not limited to those listed herein.

The second conductive wire 152 may be formed to electrically connect the side from which the second conductive tab 122 is drawn out to the second conductive external terminal 142. In addition, the second conductive wire 152 is formed on the side surface 130a of the battery case 130, which is positioned far from the side from which the second conductive tab 122 is drawn out, and is relatively long. In addition, the second conductive wire 152 is formed of a wire made of any one metal of nickel (Ni), copper (Cu), aluminum (Al) and equivalents thereof, or combinations of these materials and coated with an insulating resin. However, the material of the second conductive wire 152 is not limited to those listed herein.

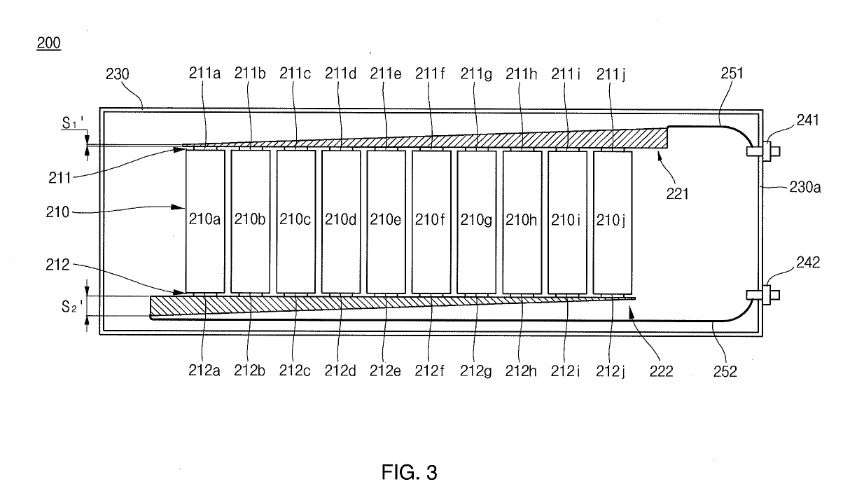

FIG. 3 is a plan view of a battery pack according to another embodiment.

Referring to FIG. 3, the battery pack 200 includes a plurality of battery cells 210, a first conductive tab 221, a second conductive tab 222, a battery case 230, a first conductive external terminal 241, a second conductive external terminal 242, a first conductive wire 251 and a second conductive wire 252. Thus, descriptions of the battery cells, the battery case, the first conductive external terminal, the second conductive external terminal, the first conductive wire and the second conductive wire will not be given since they have the same configurations in the battery pack 200 according to the illustrated embodiment and the battery pack 100 according to the previous embodiment shown in FIGS. 1 and 2.

The first conductive tab 221 is formed to electrically connect the first to 10th first conductive terminals 211a, 211b, 211c, 211d, 211e, 211f, 211g, 211h, 211i and 211j (211a-211j) of the first to 10th battery cells 210a, 210b, 210c, 210d, 210e, 210f, 210g, 210h, 210i and 210j (210a-210j) to then be drawn out in a first direction. That is to say, the first conductive tab 221 may be formed at upper portions of the first conductive terminals 211a-211j. Here, the first conductive tab 221 may be made of any one of nickel (Ni), copper (Cu), aluminum (Al) and equivalents thereof, or combinations of these materials. However, the material of the first conductive tab 221 is not limited to those listed herein. In addition, the first conductive tab 221 may be formed to have an oblique cross section of top surface substantially gradually increasing in the first direction in which it is drawn out. That is to say, the first conductive tab 221 may be formed to be substantially gradually thicker from the second direction to first direction, the second direction opposite to the first direction.

The second conductive tab 222 is formed to electrically connect the second conductive terminals 212a, 212b, 212c, 212d, 212e, 212f, 212g, 212h, 212i and 212j (212a-212j) of the first to 10th battery cells 210a-210j to then be drawn out in a second direction. That is to say, the second conductive tab 222 may be formed at lower portions of the second conductive terminals 212a-212j. Here, the second conductive tab 222 may be formed to have an oblique section of bottom surface gradually increasing in the second direction in which it is drawn out. That is to say, the first conductive tab 221 may be formed to be substantially gradually thicker from the first direction to the second direction, the first direction opposite to the second direction.

In addition, the sum of thicknesses of the first conductive tab 221 and the second conductive tab 222 formed in each of the battery cells 210a-210j may be constant. That is to say, in one embodiment, as expressed in Equation (2), the sum S′ of a thickness S1′ of the first conductive tab 221 and the thickness S2′ of the second conductive tab 222 is always constant:

S′=S1′+S2′ (2)

According to at least one embodiment, the current flowing in a conductive tab is reduced for each battery cell and the thickness of the conductive tab is varied accordingly, thereby reducing the manufacturing cost of the conductive tab and improving the yield of the battery pack.

Hereinafter, a configuration of a battery pack module according to still another embodiment will be described.

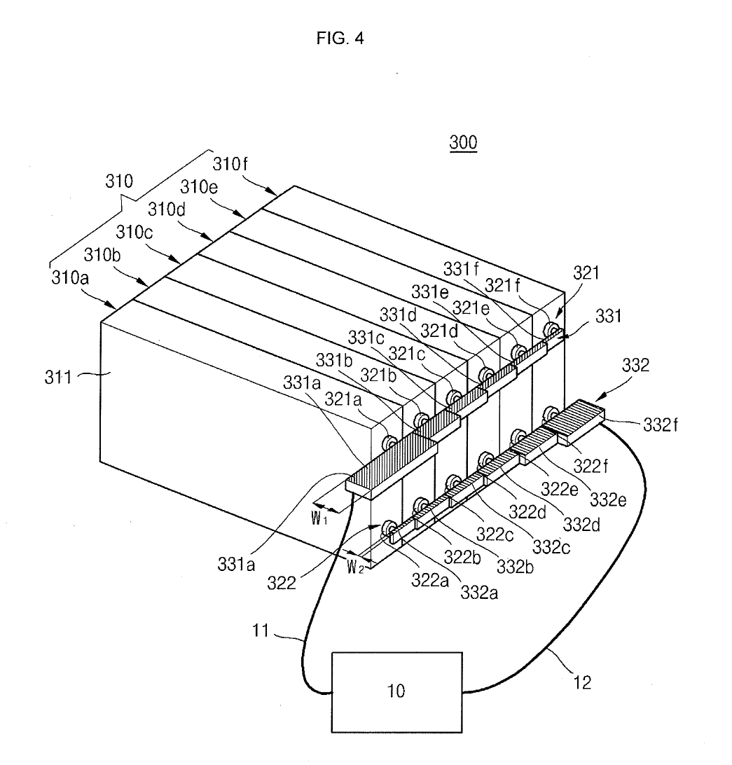

FIG. 4 is a perspective of a battery pack module according to still another embodiment.

Referring to FIG. 4, the battery pack module 300 includes a plurality of battery packs 310, first conductive external terminals 321, second conductive external terminals 322, a first conductive bus bar 331 and a second conductive bus bar 332. Since a plurality of battery cells forming the battery packs 310, a first conductive wire and a second conductive wire are substantially the same as the corresponding components of the battery pack according to the previous embodiment, detailed descriptions thereof will not be given below.

The battery packs 310 may include a plurality of battery cells (not shown), a battery case 311, first conductive external terminals 321, second conductive external terminals 322, a first conductive wire (not shown), and a second conductive wire (not shown). Although FIG. 4 illustrates six battery packs 310, the number of the battery packs 310 is not limited thereto. The battery packs 310 may be defined as first to sixth battery packs 310a, 310b, 310c, 310d, 310e and 310f (310a-310f). The first to sixth battery packs 310a-310f may be arranged in substantially parallel with each other from a first direction to a second direction opposite to the first direction.

The battery case 311 may be shaped of a box having an internal space. The battery case 311 may be formed to house the battery cells in the internal space. In addition, the battery case 311 may be formed to fix first conductive external terminals 321 and second conductive external terminals 322, which will later be described. Further, the battery case 311 may protect the battery cells housed therein from external surroundings, such as external impacts or dust.

The first conductive external terminals 321 may be formed at one side surface of the battery case 311. In addition, the first conductive external terminals 321 are electrically connected to conductive terminals of the battery cells housed therein. Further, the first conductive external terminals 321 may be exposed out of the battery case 311 to be electrically connected to another battery pack or electronic device. The first conductive external terminals 321 are electrically connected to the conductive terminals through a conductive wire.

The second conductive external terminals 322 may be formed on the one side surface of the battery case 311. In addition, the second conductive external terminals 322 may be electrically connected to the conductive terminals of the battery cells housed therein. Further, the second conductive external terminals 322 may be exposed out of the battery case 311 to be electrically connected to another battery pack or electronic device. The second conductive external terminals 322 are electrically connected to the conductive terminals through a conductive wire.

The first conductive bus bar 331 is formed to electrically connect first conductive external terminals 321a, 321b, 321c, 321d, 321e and 321f (321a-321f) of the first to sixth battery packs 310a-310f. In addition, the first conductive bus bar 331 may be electrically connected to an external device 10 at one end of the first conductive bus bar 331 through a first wire 11. In addition, the first conductive bus bar 331 may be formed to have a stepped cross section of top surface substantially gradually increasing in the first direction in which it is drawn out. That is to say, the first conductive bus bar 331 121 may be formed to be substantially gradually thicker from the second direction to the first direction, the second direction opposite to the first direction. Although FIG. 4 illustrates the first conductive bus bar 331 including a plurality of bus bars connected on the first conductive external terminals 321a-321f, this structure is not considered limiting. However, plate-shaped conductive bus bars connecting the first conductive external terminals 321a-321f to each other may be stacked and formed stepwise.

The second conductive bus bar 332 is formed to electrically connect second conductive external terminals 322a, 322b, 322c, 322d, 322e and 322f (322a-322f) of the first to sixth battery packs 310a-310f. In addition, the second conductive bus bar 332 may be electrically connected to an external device 10 at one end of the second conductive bus bar 332 through a second wire 12. In addition, the second conductive bus bar 332 may be formed to have a stepped cross section of top surface substantially gradually increasing in the second direction in which it is drawn out. That is to say, the second conductive bus bar 332 may be formed to be substantially gradually thicker from the first direction to the second direction, the first direction opposite to the second direction. Although FIG. 4 illustrates the second conductive bus bar 332 including a plurality of bus bars connected on the second conductive external terminals 322a-322f, this structure is not considered limiting. However, plate-shaped conductive bus bars connecting the second conductive external terminals 322a-322f to each other may be stacked and formed stepwise.

Thicknesses of the aforementioned first and second conductive bus bars 331 and 332 at an end of at least one of the first and second directions, in which the first and second conductive bus bars 331 and 332 are drawn out may be different from each other.

The first and second conductive bus bars 331 and 332 may be formed to be spaced apart from each other at side surfaces of the battery packs 310a-310f, respectively. However, the locations of the conductive bars 331 and 332 are not limited to the above. In addition, the sum of thicknesses of the first and second conductive bus bars 331 and 332 formed in each of the battery packs 310a-310f may be constant. That is to say, in one embodiment, as expressed in Equation (3), the sum W of the thickness W1 of the first conductive bus bar 331 and thickness W2 of the second conductive bus bar 332 is always constant:

W=W1+W2 (3)

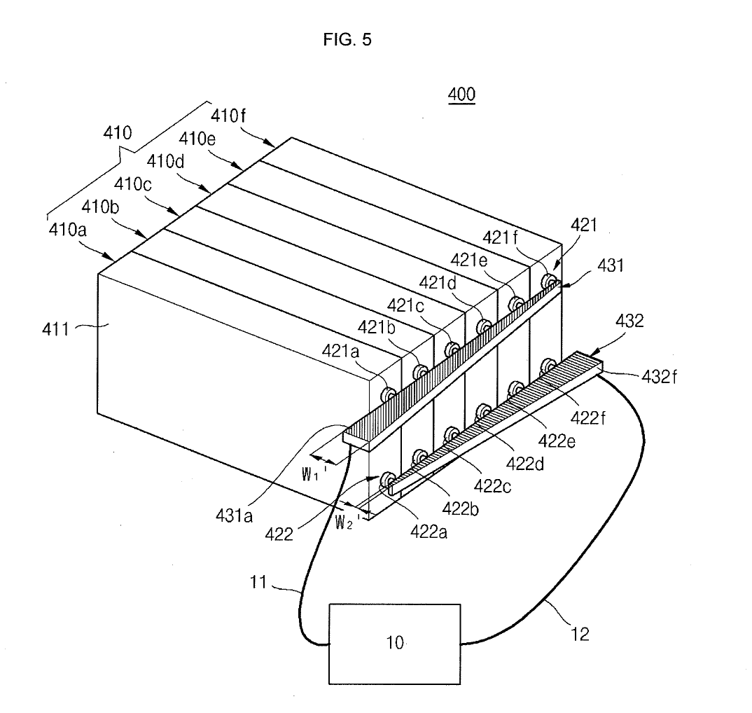

FIG. 5 is a perspective of a battery pack module according to still another embodiment.

Referring to FIG. 5, the battery pack module 400 includes a plurality of battery packs 410, first conductive external terminals 421, second conductive external terminals 422, a first conductive bus bar 431, and a second conductive bus bar 432. Thus, descriptions of the battery packs, the first conductive external terminals, and the second conductive external terminals will not be given below since they have the same configurations in the battery pack module 400 according to the illustrated embodiment and the battery pack module 300 according to the previous embodiment shown in FIG. 4.

The first conductive bus bar 431 is formed to electrically connect first conductive external terminals 421a, 421b, 421c, 421d, 421e and 421f (421a-421f) of the first to sixth battery packs 410a, 410b, 410c, 410d, 410e and 410f (410a-410f). In addition, the first conductive bus bar 431 may be electrically connected to an external device 10 at one end of the first conductive bus bar 431 through a first wire 11. In addition, the first conductive bus bar 431 may be formed to have an oblique cross section of top surface substantially gradually increasing in the first direction in which it is drawn out. That is to say, the first conductive bus bar 431 may be formed to be substantially gradually thicker from the second direction to the first direction, the second direction opposite to the first direction.

The second conductive bus bar 432 is formed to electrically connect second conductive external terminals 422a, 422b, 422c, 422d, 422e and 422f (422a-422f) of the first to sixth battery packs 410a-410f. In addition, the second conductive bus bar 432 may be electrically connected to an external device 10 at one end of the second conductive bus bar 432 through a second wire 12. In addition, the second conductive bus bar 432 may be formed to have an oblique cross section of top surface substantially gradually increasing in the second direction in which it is drawn out. That is to say, the second conductive bus bar 432 may be formed to be substantially gradually thicker from the first direction to the second direction, the first direction opposite to the second direction.

The first conductive bus bar 431 and the second conductive bus bar 432 may be formed to be spaced apart from each other at side surfaces of the battery packs 410a-410f, respectively. However, the locations of the conductive bus bars 431 and 432 are not limited to the above. In addition, the sum of thicknesses of the first and second conductive bus bars 431 and 432 formed in each of the battery packs 410a-410f may be constant. That is to say, in one embodiment, as expressed in Equation (4), the sum W′ of the thickness W1′ of the first conductive bus bar 431 and thickness W2′ of the second conductive bus bar 432 is always constant:

W′=W1′+W2′ (4)

According to at least one of the disclosed embodiments, the current flowing in a conductive tab is reduced for each battery pack and the thickness of the bus bar is varied accordingly, thereby reducing the manufacturing cost of the bus bar and improving the yield of the battery pack module.

Furthermore, the thicknesses of the electrode tabs or bus bars are varied, thereby reducing the manufacturing cost of the electrode tabs or bus bars and improving the yield of the battery packs and battery pack modules.

While embodiments have been described with reference to the accompanying drawings, it is to be understood that various modifications and equivalent arrangements are included within the spirit and scope of the appended claims.

What is claimed is:

1. A battery pack comprising:
a plurality of battery cells each including a first conductive terminal and a second conductive terminal, wherein the battery cells are electrically connected in parallel to each other;
a plurality of first conductive tabs respectively connected to the first conductive terminals and extending in a first direction; and
a plurality of second conductive tabs respectively connected to the second conductive terminals and extending in a second direction substantially opposite to the first direction, wherein the first conductive tabs face and correspond to the second conductive tabs, respectively,
wherein a selected one of the first conductive tabs has a thickness different from that of the corresponding second conductive tab.

2. The battery pack of claim 1, wherein each of the first conductive tabs has first top and first bottom surfaces, wherein the first bottom surfaces contact the first conductive terminals, respectively, wherein each of the second conductive tabs has second top and second bottom surfaces, and wherein the second top surfaces contact the second conductive terminals, respectively.

3. The battery pack of claim 2, wherein the first conductive tabs have stepped cross sections along the first top surfaces, and wherein the second conductive tabs have stepped cross sections along the second bottom surfaces.

4. The battery pack of claim 2, wherein the first conductive tabs have oblique cross sections along the first top surfaces and wherein the second conductive tabs have oblique cross sections along the second bottom surfaces.

5. The battery pack of claim 1, wherein the thicknesses of the first conductive tabs gradually decrease in the first direction, and wherein the thicknesses of the second conductive tabs gradually decrease in the second direction.

6. The battery pack of claim 1, wherein the sum of thicknesses of a selected first conductive tab and the corresponding second conductive tab is substantially constant.

7. The battery pack of claim 1, wherein each of the first conductive tabs and each of the second conductive tabs are formed of at least one of the following: nickel (Ni), copper (Cu) and aluminum (Al).

8. The battery pack of claim 1, further comprising:
a first conductive external terminal electrically connected to the first conductive tabs; and
a second conductive external terminal electrically connected to the second conductive tabs.

9. The battery pack of claim 8, wherein the first conductive tabs and the first conductive external terminals are electrically connected to each other via a first conductive wire, and wherein the second conductive tabs and the second conductive external terminals are electrically connected to each other via a second conductive wire.

10. The battery pack of claim 8, further comprising a battery case accommodating the battery cells therein, wherein the first and second conductive external terminals are attached to the battery case.

11. The battery pack of claim 1, wherein the battery cells are cylindrical rechargeable batteries.

12. The battery pack of claim 1, wherein the first and second conductive terminals are formed on the opposite sides of the battery cells.

13. A battery pack module comprising:
a plurality of battery packs each including a first conductive external terminal and a second conductive external terminal, wherein the battery packs are electrically connected in parallel to each other;
a plurality of first conductive bus bars respectively connected to the first conductive external terminals and extending in a first direction; and
a plurality of second conductive bus bars respectively connected to the second conductive external terminals and extending in a second direction substantially opposite to the first direction, wherein the first conductive bus bars face and correspond to the second conductive bus bars, respectively, and wherein the first conductive bus bars are arranged substantially parallel with the second conductive bus bars,
wherein a selected one of the first conductive bus bars has a thickness different from that of the corresponding second conductive bus bar.

14. The battery pack module of claim 13, wherein each of the first conductive bus bars has first top and first bottom surfaces, wherein the first bottom surfaces contact the first conductive external terminals, respectively, wherein each of the second conductive bus bars has second top and second bottom surfaces, and wherein the second bottom surfaces contact the second conductive terminals, respectively.

15. The battery pack of claim 14, wherein the first conductive bus bars have stepped cross sections along the first top surfaces, and wherein the second conductive bus bars have stepped cross sections along the second top surfaces.

16. The battery pack of claim 14, wherein the first conductive bus bars have oblique cross sections along the first top surfaces and wherein the second conductive bus bars have oblique cross sections along the second top surfaces.

17. The battery pack of claim 13, wherein the thicknesses of the first conductive bus bars gradually decrease in the first direction, and wherein the thicknesses of the second conductive bus bars gradually decrease in the second direction.

18. The battery pack module of claim 13, wherein the first and second conductive external terminals are formed on the same side of the battery cells.

19. A battery pack comprising:
a plurality of battery cells each including a first conductive terminal and a second conductive terminal, wherein the battery cells are electrically connected in parallel to each other;
a plurality of first conductive tabs respectively connected to the first conductive terminals and extending in a first direction; and
a plurality of second conductive tabs respectively connected to the second conductive terminals and extending in a second direction substantially opposite to the first direction, wherein the first conductive tabs face and correspond to the second conductive tabs, respectively,
wherein the thicknesses of the first conductive tabs gradually decrease in the first direction, and wherein the thicknesses of the second conductive tabs gradually decrease in the second direction.

20. The battery pack of claim 19, wherein the sum of thicknesses of a selected first conductive tab and the corresponding second conductive tab is substantially constant.
